(19) United States
(12) Patent Application Publication
(10) Pub. No.: US 2025/0343296 A1
(43) Pub. Date: Nov. 6, 2025

(54) COOLING STRUCTURE FOR BATTERY ASSEMBLY

(71) Applicant: GM Global Technology Operations LLC, Detroit, MI (US)

(72) Inventors: Liang Xi, Northville, MI (US); Alfredo Salituro, Ferndale, MI (US); Srikant Srinivasan, Novi, MI (US); SriLakshmi Katar, Troy, MI (US); Christopher C. Elliott, Clarkston, MI (US); Sara Arendell, Waterford, MI (US); Phillip Daniel Hamelin, Clarkston, MI (US); Alexander M. Bilinski, Avoca, MI (US)

(21) Appl. No.: 18/651,945

(22) Filed: May 1, 2024

(51) Int. Cl. H01M 10/656; B60L 50/60; B60L 50/64; H01M 10/613; H01M 10/625; H01M 10/6554; H01M 10/658; H01M 50/209; H01M 50/507; H01M 50/519

(52) U.S. Cl. CPC H01M 10/656; B60L 50/64; H01M 10/613; H01M 10/625; H01M 10/6554; H01M 10/658; H01M 50/209; H01M 50/507; H01M 50/519; B60L 50/66; H01M 2220/20

(57) ABSTRACT

A battery assembly defines a first axis, a second axis orthogonal to the first axis, and a third axis orthogonal to the first axis and the second axis and includes a plurality of battery cells arranged along the third axis, and an integrated circuit board (ICB) assembly disposed adjacent to the battery cells along the first axis and electrically coupled to the plurality of battery cells. The ICB assembly includes a cooling structure thermally coupled to the battery cells. The cooling structure includes a main body defining at least one cooling fluid flowpath configured to have cooling fluid pass therethrough to remove heat from the battery cells.

### INTRODUCTION

The subject disclosure relates to the art of rechargeable energy storage systems and, more particularly, to a battery assembly with a cooling structure.

Rechargeable energy storage systems may include different types of rechargeable energy storage cells disposed in a casing with plates. In rechargeable energy storage systems, improvements in cooling are desirable.

### SUMMARY

In one exemplary embodiment, a battery assembly defines a first axis, a second axis orthogonal to the first axis, and a third axis orthogonal to the first axis and the second axis, and comprises a plurality of battery cells arranged along the third axis, and an integrated circuit board (ICB) assembly disposed adjacent to the battery cells along the first axis and electrically coupled to the plurality of battery cells. The ICB assembly comprises a cooling structure thermally coupled to the battery cells. The cooling structure comprises a main body defining at least one cooling fluid flowpath configured to have cooling fluid pass therethrough to remove heat from the battery cells.

In addition to one or more of the features described herein, the at least one cooling fluid flowpath comprises a first portion extending along the third axis and a second portion extending along the third axis disposed adjacent to the first portion along the first axis.

In addition to one or more of the features described herein, a thermal barrier is disposed between the first portion and the second portion.

In addition to one or more of the features described herein, the main body is formed of a first body defining the first portion and a second body defining the second portion, the first body is separate from the second body, and the thermal barrier is disposed between the first body and the second body.

In addition to one or more of the features described herein, the first portion is a first flowpath extending from a first flowpath inlet disposed at one end of the main body along the third axis to a first flowpath outlet disposed at another end of the main body along the third axis, and the second portion is a second flowpath extending from a second flowpath inlet disposed at the one end of the main body along the third axis to a second flowpath outlet disposed at the other end of the main body along the third axis.

In addition to one or more of the features described herein, the first portion extends from a flowpath inlet disposed at one end of the main body along the third axis to a flowpath bend portion, the second portion extends from the flowpath bend portion to a flowpath outlet disposed at the one end of the main body along the third axis, and the flowpath bend portion fluidly couples the first portion to the second portion.

In addition to one or more of the features described herein, the main body comprises an end cap that that defines the flowpath bend portion.

In addition to one or more of the features described herein, the at least one cooling fluid flowpath comprises a first flowpath and a second flowpath arranged adjacent to the first flowpath, the first flowpath extends from a first flowpath inlet disposed at one end of the main body along the third axis to a first flowpath bend portion and further extends from the first flowpath bend portion along the third axis to a first flowpath outlet disposed on the one end of the main body, and the second flowpath extends from a second flowpath inlet disposed at the one end of the main body along the third axis to a second flowpath bend portion and further extends from the second flowpath bend portion along the third axis to a second flowpath outlet disposed on the one end of the main body.

In addition to one or more of the features described herein, each of the battery cells comprises a can and an electrode stack disposed within the can, a thermal interface material is disposed between and in contact with the can and the cooling structure to transfer heat from the can to the cooling structure.

In addition to one or more of the features described herein, wherein a thermally conductive material is disposed between and in contact with the electrode stack and an inner surface of a portion of the can that contacts the thermal interface material.

In addition to one or more of the features described herein, the ICB assembly comprises a first bus bar and a second bus bar, each of which is electrically coupled to one or more the battery cells, and the cooling structure is disposed between the first bus bar and the second bus bar along the second axis.

In addition to one or more of the features described herein, the ICB assembly comprises a first bus bar and a second bus bar, each of which is electrically coupled to one or more the battery cells, and the cooling structure is disposed between the first bus bar and the second bus bar along the second axis.

In addition to one or more of the features described herein, a first thermal bridge plate and a second thermal bridge plate are disposed on a side of the ICB assembly facing the battery cells along the first axis, the first thermal bridge plate extends along the second axis from the thermal interface material to a position overlapping the first bus bar along the first axis, the second thermal bridge plate extends along the second axis from the thermal interface material to a position overlapping the second bus bar along the first axis, and the first thermal bridge plate and the second thermal bridge plate are thermal conductors and electrical insulators.

In addition to one or more of the features described herein, the first thermal bridge plate and the second thermal bridge plate comprises a ceramic material.

In addition to one or more of the features described herein, first and second thermal interface materials are disposed on a side of the cooling structure opposite the battery cell, a first thermal bridge plate extends along the second axis so as to overlap and be in contact with the first bus bar and the first thermal interface material along the first axis, and a second thermal bridge plate extends along the second axis so as to overlap and be in contact with the second bus bar and the second thermal interface material along the first axis.

In addition to one or more of the features described herein, the ICB assembly comprises a plurality of the cooling structure arranged along the second axis.

In addition to one or more of the features described herein, a flowpath inlet of the at least one cooling fluid flowpath and a flowpath outlet of the at least one cooling fluid flowpath are fluidly coupled to a pump and a heat exchanger, to form a cooling fluid loop.

In addition to one or more of the features described herein, the battery assembly further comprises cooling plates disposed on sides of the battery cell along the second axis.

In another exemplary embodiment, an integrated circuit board (ICB) assembly for a battery assembly defining a first axis, a second axis orthogonal to the first axis, and a third axis orthogonal to the first axis and the second axis. The ICB assembly comprises an integrated circuit board (ICB) assembly configured to be disposed adjacent to a plurality of battery cells along the first axis and configured to be electrically coupled to the plurality of battery cells. The ICB assembly comprises a cooling structure configured to be thermally coupled to the battery cells. The cooling structure comprises a main body defining at least one cooling fluid flowpath configured to have cooling fluid pass therethrough to remove heat from the battery cells.

In yet another exemplary embodiment, a vehicle comprises a battery assembly defining a first axis, a second axis orthogonal to the first axis, and a third axis orthogonal to the first axis and the second axis. The battery assembly comprises a plurality of battery cells arranged along the third axis, and an integrated circuit board (ICB) assembly disposed adjacent to the battery cells along the first axis and electrically coupled to the plurality of battery cells. The ICB assembly comprises a cooling structure thermally coupled to the battery cells. The cooling structure comprises a main body defining at least one cooling fluid flowpath configured to have cooling fluid pass therethrough to remove heat from the battery cells. The at least one cooling fluid flowpath comprises a first portion extending along the third axis and a second portion extending along the third axis disposed adjacent to the first portion along the first axis or the second axis. The ICB assembly comprises a first bus bar and a second bus bar, each of which is electrically coupled to one or more the battery cells. The cooling structure is disposed between the first bus bar and the second bus bar along the second axis.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a battery pack according to a non-limiting example;

FIG. 2 is a front view of a battery assembly according to one or more embodiments;

FIG. 3 is a bottom view of an integrated circuit board assembly according to one or more embodiments;

FIG. 4. is a schematic diagram showing a cooling loop according to one or more embodiments;

FIG. 5 is a front view of a cooling structure according to one or more embodiments;

FIG. 6 is a cross-sectional view of the cooling structure of FIG. 5 taken at 6-6;

FIG. 7 is a front view of a cooling structure according to one or more embodiments;

FIG. 8 is a cross-sectional view of the cooling structure of FIG. 7 taken at 8-8;

FIG. 9 is a front view of a cooling structure according to one or more embodiments;

FIG. 10 is a cross-sectional view of the cooling structure of FIG. 9 taken at 10-10;

FIG. 11 is a front view of a cooling structure according to one or more embodiments;

FIG. 12 is a cross-sectional view of the cooling structure of FIG. 11 taken at XII-XII;

FIG. 13 is a front view of an integrated circuit board assembly according to one or more embodiments;

FIG. 14 is a front view of an integrated circuit board assembly according to one or more embodiments;

FIG. 15 is a front view of an integrated circuit board assembly according to one or more embodiments; and

FIG. 16 is a cross-sectional view of an alternate embodiment of the cooling structure of FIG. 7 taken at 8-8.

### DETAILED DESCRIPTION

The following description is merely exemplary in nature and is not intended to limit the present disclosure, its application or uses. It should be understood that throughout the drawings, corresponding reference numerals indicate like or corresponding parts and features.

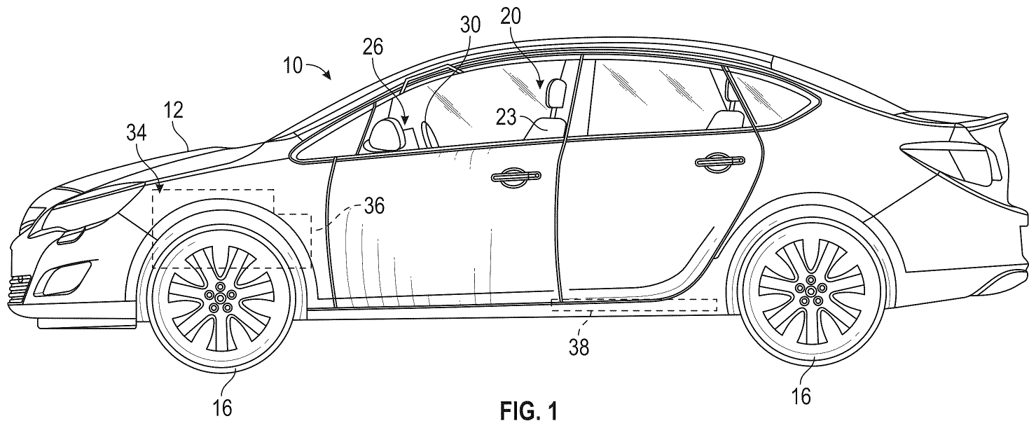

A vehicle 10 according to a non-limiting example is shown in FIG. 1. The vehicle 10 includes a body 12 supported on a plurality of wheels 16. One or more of the plurality of wheels 16 are steerable. The body 12 defines, in part, a passenger compartment 20 having seats 23 positioned behind a dashboard 26. A steering control 30 is arranged between seats 23 and a dashboard 26. The steering control 30 is operated to control orientation of the steerable wheel(s) 16.

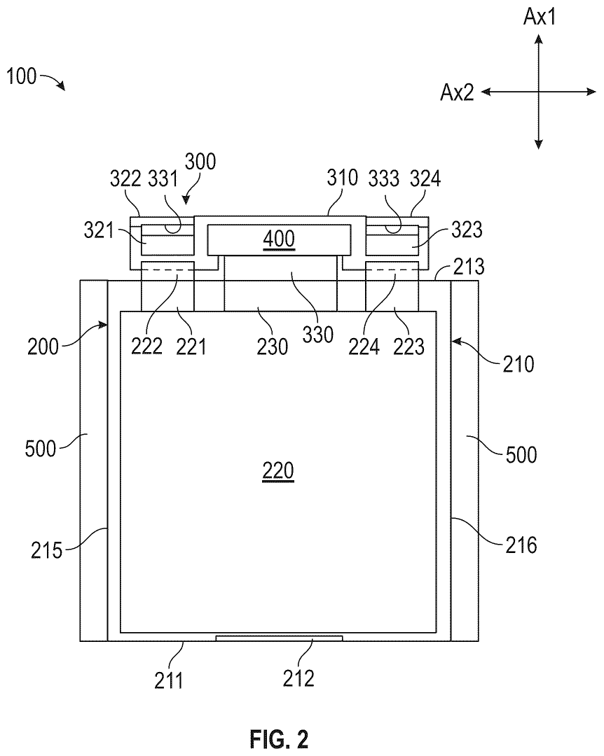

The vehicle 10 includes an electric motor 34 connected to a gear assembly and/or transmission 36 that provides power to one or more of the plurality of wheels 16. A rechargeable energy storage system 38 is arranged in the body 12 and provides power to the electric motor 34. While specific locations are shown for the electric motor 34, the gear assembly and/or transmission 36, and the rechargeable energy storage system 38 in FIG. 1, these locations are merely exemplary and not limiting, and locations of these structures may vary. According to one or more embodiments, the rechargeable energy storage system 38 includes a battery assembly 100 as shown in FIG. 2.

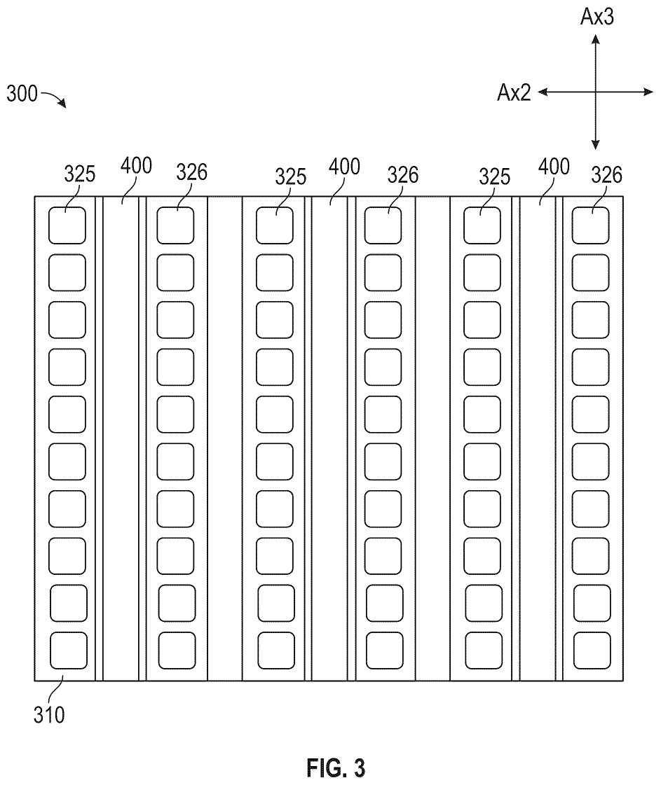

FIG. 2 shows a battery assembly 100 according to one or more embodiments. The battery assembly 100 includes a plurality of battery cells 200 and an integrated circuit board (“ICB”) assembly 300. The ICB assembly 300 is also shown in FIG. 3. The battery assembly 100 defines a first axis Ax1, a second axis Ax2 orthogonal to the first axis Ax1, and a third axis Ax3 orthogonal to the first axis Ax1 and the second axis Ax2 (see FIG. 3). According to one or more embodiments, the first axis Ax1 may be a vertical axis, the second axis Ax2 may be a lateral axis, and the third axis Ax3 may be a longitudinal axis. The ICB assembly 300 may be disposed above the battery cell 200 along the third axis Ax3.

The plurality of battery cells 200 are arranged along the third axis Ax3. The plurality of battery cells 200 may form a stack long the third axis Ax3. The battery cells 200 may be prismatic cells The battery assembly 100 may include multiple rows of the battery cells 200 arranged along the third axis Ax3. For example, the ICB assembly 300 shown in FIG. 3 may be disposed on thirty battery cells 200, with ten batteries along the third axis Ax3 and three batteries along the second axis Ax2. However, the battery assembly 100 is not limited to any number of battery cells 200.

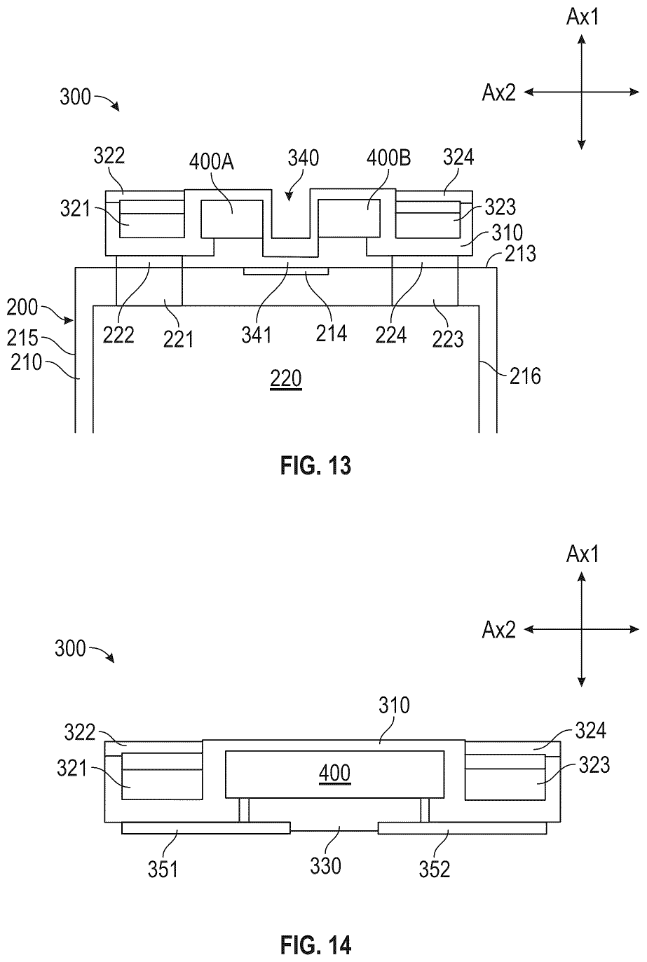

Each of the battery cells 200 may include a can 210 in which an electrode stack 220 or an electrode package including a plurality of electrode stacks 220 is disposed. The electrode stack 220 may include anode electrodes, cathode electrodes, and separators. The can 210 may include a lower wall 211 and an upper wall 213 on opposite ends along the first axis Ax1, and side walls 215, 216 on opposite ends along the second axis Ax2. The can 210 may further include front and rear walls (not shown) on opposite ends along the third axis Ax3. According to one or more embodiments, a lower vent 212 may be formed in the lower wall 211, and/or an upper vent 214 (see FIG. 13) may be formed on the upper wall 213. The upper vent 214 may face the ICB assembly 300.

Each of the battery cells 200 may further include a first electrode tab 221 extending from the electrode stack 220 within the can 210, and a first electrode terminal 222 electrically connected to the first electrode tab 221 and extending from the upper wall 213 to the ICB assembly 300. The first electrode tab may be one of a positive electrode tab and a negative electrode tab, and the second electrode tab may be the other of the positive electrode tab and the negative electrode tab. Each of the battery cells 200 may further include a second electrode tab 223 extending from the electrode stack 220 within the can 210, and a second electrode terminal 224 electrically connected to the second electrode tab 223 and extending from the upper wall 213 to the ICB assembly 300.

According to one or more embodiments, a thermally conductive material 230 is disposed between a top surface of the electrode stack 220 and an inner surface of the upper wall 213 of the can 210 so as to transfer heat from the electrode stack 220 to the upper wall 213 of the can 210. The thermally conductive material 230 may be aluminum oxide ceramic solid, any ceramic material, or any thermally conductive material known in the art may be electrically insulating.

Cooling plates 500 may be disposed on the side walls 215, 216 of the can 210 to remove heat from the can 210. Each of the cooling plates 500 may be in contact with cans 210 of multiple battery cells 200.

The ICB assembly 300 may include an ICB frame 310. A plurality of first ICB terminals 325, FIG. 3, electrically connected to the first electrode terminal 222 of the battery cells 200 and a plurality of second ICB terminals 326 electrically connected to the second electrode terminal 224 of the battery cells 200.

The ICB assembly 300 may include recessed portions in which a plurality of first bus bars 321 and a plurality of second bus bars 323 are disposed. First covers 322 may be disposed above the first bus bars 321 along the first axis Ax1 and second covers 324 may be disposed above the second bus bars 323 along the first axis Ax1. A bottom surface 331 of the first covers 322 may be spaced from the first bus bars 321 along the first axis Ax1, and a bottom surface 333 of the second covers 324 may be spaced from the second bus bars 323 along the first axis Ax1.

The first bus bars 321 may be electrically connected to the first ICB terminals 325, and the second bus bars 323 may be electrically connected to the second ICB terminals 326. The first bus bars 321, the first ICB terminals 325, the first electrode terminal 222, and the first electrode tab 221 may overlap along the first axis Ax1, and the second bus bars 323, the second ICB terminals 326, the second electrode terminal 224, and the second electrode tab 223 may overlap along the first axis Ax1.

The ICB assembly 300 may include a plurality of cooling structures 400 that extend along the third axis Ax3 and arranged along the second axis Ax2. The cooling structures 400 may be parallel to each other. A cooling structure 400 may be, for example, a cooling ribbon, which is a ribbon shaped cooling tube(s). Thermal interface material 330 may be disposed between the cooling structure 400 and the upper wall 213 of the can 210 of the battery cell 200. The thermal interface material 330 may be a gap filler, and may be formed of aluminum oxide polyurethane, aluminum tri-hydrate polyurethane, or any other type of thermally conductive material known in the art. The cooling structure 400 may be formed of Aluminum. As non-limiting examples, the cooling ribbon 400 may formed of Aluminum 1050, 1100, 3003, 3102, 6005, 6063, 6463, or may be customized Aluminum. Alternatively, the cooling ribbon 400 may be formed of other materials known in the art.

The bottom surface of the cooling structure 400 may be in contact with the thermal interface material 330 to remove heat from the battery cell 200 through the thermal interface material 330. The cooling structures 400 may be disposed between the first bus bars 321 and the second bus bars 323 along the second axis Ax2. Additionally or alternatively, the cooling structures 400 may be disposed between the first ICB terminals 325 and the second ICB terminals 326 along the second axis Ax2.

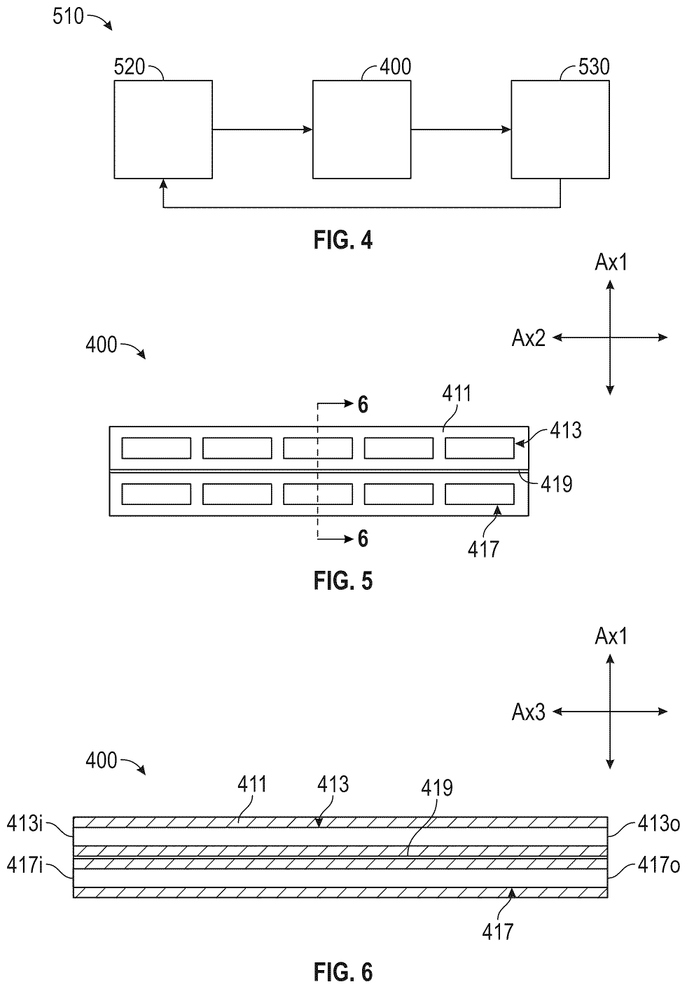

FIG. 4 shows a cooling system flow loop 510 including one or more cooling structures 400 according to one or more embodiments. A cooling fluid is disposed within the cooling system flow loop 510. According to one or more embodiments, the cooling fluid may be water, ethylene glycol, dielectric fluid, transmission fluid, transmission fluid, a mixture thereof, or any other cooling fluids known in the art. The flow loop 510 may include a pump 520 that increases the pressure of the cooling fluid to flow the fluid into one or more inlets of the cooling structures 400 and through the cooling structures 400 to remove heat from the cooling structures 400 (i.e., cooling the cooling structures 400). The cooling fluid may exit the cooling structures 400 through one or more outlets (not shown) of the cooling structures 400. The cooling system flow loop 510 may further include one or more heat exchangers 530 for removing heat from the cooling fluid exiting the cooling structures 400 (i.e., cooling the cooling fluid). The cooling fluid cooled by the heat exchanger 530 is fed back into the cooling structure 400 via the pump 520. While FIG. 4 shows the one or more heat exchangers 530 upstream of the pump 520, the one or more heat exchangers 530 may be disposed upstream of the pump 520.

FIGS. 5 and 6 show a cooling structure 400 according to one or more embodiments. The cooling structure 400 may be, for example, a cooling ribbon. The cooling structure 400 includes a main body 411 that defines a plurality of upper cooling fluid flowpaths 413 arranged along the second axis Ax2 at an upper portion thereof and a plurality of lower cooling fluid flowpaths 417 at a lower portion thereof. Each of the upper cooling fluid flowpaths 413 may extend from an upper flowpath inlet 413i positioned at a front end of the main body 411 along the third axis Ax3 to an upper flowpath outlet 4130 positioned at a rear end of the main body 411 along the third axis Ax3. The cooling structure 400 may further include a thermal barrier 419 between the upper cooling fluid flowpaths 413 and the lower cooling fluid flowpaths 417. While FIG. 5 shows five upper cooling fluid flowpaths 413 arranged along the second axis Ax2 and five lower cooling fluid flowpaths 417 arranged along the second axis Ax2, the present disclosure is not limited thereto, and any number of the upper cooling fluid flowpaths 413 and the lower cooling fluid flowpaths 417 may be arranged along the second axis Ax2.

The upper flowpath inlets 413i and the lower flowpath inlets 417i may be coupled to one end of one or more cooling system flow loops 510, and the upper flowpath outlets 4130 and the lower flowpath outlets 4170 may be coupled to the other end of one or more cooling system flow loops 510. Thus, cold cooling fluid may flow into the cooling structure 400 from the upper flowpath inlets 413i and the lower flowpath inlets 417i, absorb heat from the main body 411, and the heated cooling fluid may flow out of the cooling structure 400 from the upper flowpath outlets 4130 and the lower flowpath outlets 4170. The heated cooling fluid may then be cooled via the heat exchanger 530 and flow back into the cooling structure 400.

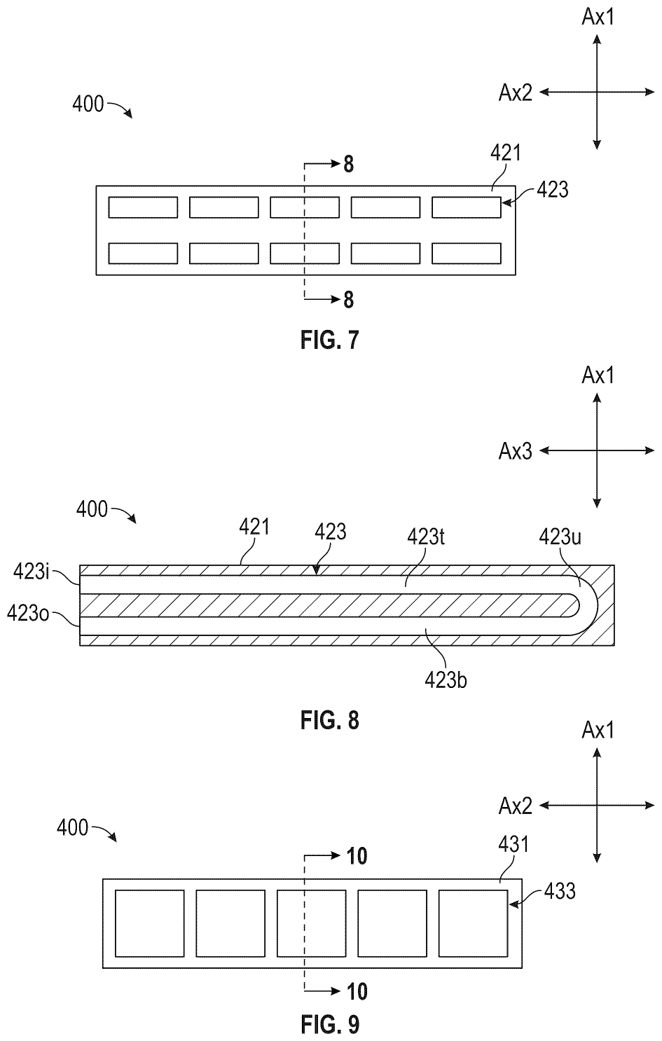

FIGS. 7 and 8 show a cooling structure 400 according to one or more embodiments. The cooling structure 400 may be, for example, a cooling ribbon. The cooling structure 400 includes a main body 421 that defines a plurality of cooling fluid flowpaths 423 arranged along the second axis Ax2. Each of the cooling fluid flowpaths 423 may extend from a flowpath inlet 423i positioned at a front end of the main body 421 along the third axis Ax3 to a flowpath bend portion 423u proximate to a rear end of the main body 421 along the third axis Ax3, curves at the flowpath bend portion 423u, and extends back to a flowpath outlet 4230 positioned at the front end of the main body 421 along the third axis Ax3. Portions of the cooling fluid flowpaths 423 between the flowpath inlets 423i and the flowpath bend portions 423u may be referred to as upper flowpaths 423t, and portions of the cooling fluid flowpaths 423 between the flowpath bend portions 423u and the flowpath outlets 4230 may be referred to as lower flowpaths 423b. The flowpath bend portion 423u may be U-shaped. While FIGS. 7 and 8 show the flowpath inlets 423i above the flowpath outlets 4230 along the first axis Ax1, the present disclosure is not limited thereto, and the flowpath outlets 4230 may be positioned above the flowpath inlets 423i along the first axis Ax1. The cooling structure 400 may further include a thermal barrier (not shown) between the upper flowpaths 423t and the lower flowpaths 423b. While FIG. 7 shows five cooling fluid flowpaths 423 arranged along the second axis Ax2, the present disclosure is not limited thereto, and any number of the cooling fluid flowpaths 423 may be arranged along the second axis Ax2.

The flowpath inlets 423i may be coupled to one end of one or more cooling system flow loops 510, and the flowpath outlets 4230 may be coupled to the other end of one or more cooling system flow loops 510. Thus, cold cooling fluid may flow into the cooling structure 400 from the flowpath inlets 423i, absorb heat from the main body 421, and the heated cooling fluid may flow out of the cooling structure 400 from the flowpath outlets 4230. The heated cooling fluid may then be cooled via the heat exchanger 530 and flow back into the cooling structure 400.

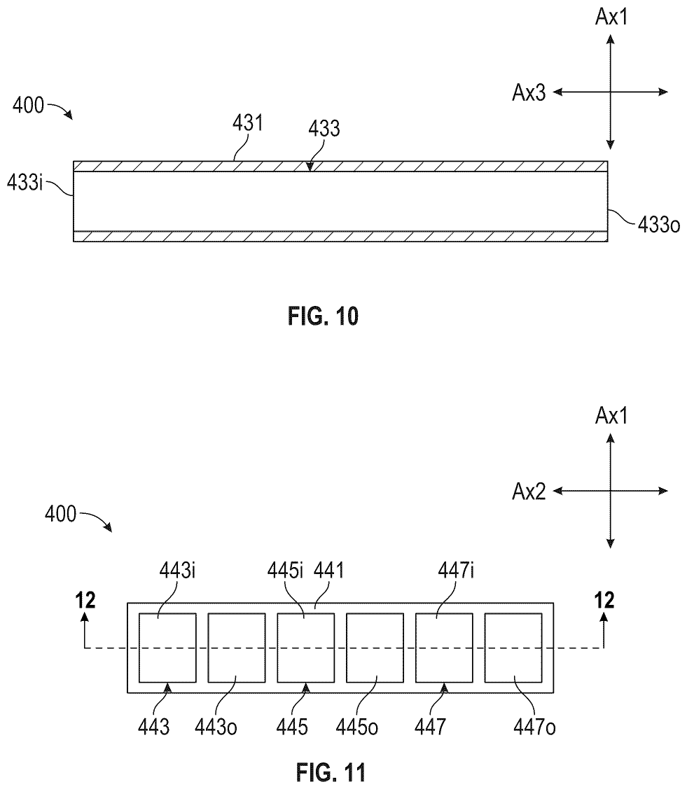

FIGS. 9 and 10 show a cooling structure 400 according to one or more embodiments. The cooling structure 400 may be, for example, a cooling ribbon. The cooling structure 400 includes a main body 431 that defines a plurality of cooling fluid flowpaths 433 arranged along the second axis Ax2. Each of the cooling fluid flowpaths 433 may extend from a flowpath inlet 433i positioned at a front end of the main body 431 along the third axis Ax3 to a flowpath outlet 4330 at a rear end of the main body 431 along the third axis Ax3. While FIG. 9 shows five cooling fluid flowpaths 433 arranged along the second axis Ax2, the present disclosure is not limited thereto, and any number of the cooling fluid flowpaths 433 may be arranged along the second axis Ax2.

The flowpath inlets 433i may be coupled to one end of one or more cooling system flow loops 510, and the flowpath outlets 4330 may be coupled to the other end of one or more cooling system flow loops 510. Thus, cold cooling fluid may flow into the cooling structure 400 from the flowpath inlets 433i, absorb heat from the main body 431, and the heated cooling fluid may flow out of the cooling structure 400 from the flowpath outlets 4330. The heated cooling fluid may then be cooled via the heat exchanger 530 and flow back into the cooling structure 400.

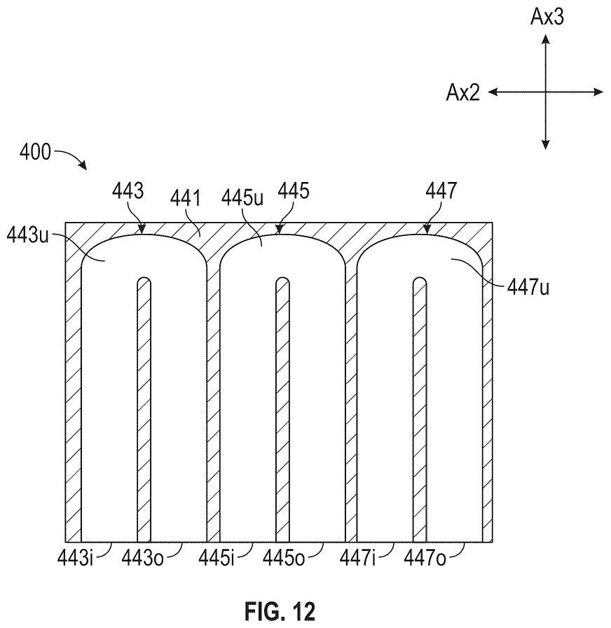

FIGS. 11 and 12 show a cooling structure 400 according to one or more embodiments. The cooling structure 400 may be, for example, a cooling ribbon. The cooling structure 400 includes a main body 441 that defines a first cooling fluid flowpath 443, a second cooling fluid flowpath 445, and a third cooling fluid flowpath 447 arranged along the second axis Ax2. The first cooling fluid flowpath 443 may extend from a first flowpath inlet 443i positioned at a front end of the main body 441 along the third axis Ax3 to a first flowpath bend portion 443u proximate to a rear end of the main body 441 along the third axis Ax3, curves at the first flowpath bend portion 443u, and extends back to a first flowpath outlet 4430 positioned at the front end of the main body 441 along the third axis Ax3. The second cooling fluid flowpath 445 may extend from a second flowpath inlet 445i positioned at the front end of the main body 441 along the third axis Ax3 to a second flowpath bend portion 445u proximate to the rear end of the main body 441 along the third axis Ax3, curves at the second flowpath bend portion 445u, and extends back to a second flowpath outlet 4450 positioned at the front end of the main body 441 along the third axis Ax3. The third cooling fluid flowpath 447 may extend from a third flowpath inlet 447ipositioned at the front end of the main body 441 along the third axis Ax3 to a third flowpath bend portion 447u proximate to the rear end of the main body 441 along the third axis Ax3, curves at the third flowpath bend portion 447u, and extends back to a third flowpath outlet 4470 positioned at the front end of the main body 441 along the third axis Ax3.

The first, second, and third flowpath bend portion 443u, 445u, 447u may be U-shaped. While FIGS. 11 and 12 show the first, second, and third flowpath inlets 443i, 445i, 447i to the left of the first, second, and third flowpath outlets 4430, 4450, 4470 along the second axis Ax2, the present disclosure is not limited thereto, and the flowpath outlets 4230 may be positioned to the right of the first, second, and third flowpath inlets 443i, 445i, 447i along the second axis Ax3. The cooling structure 400 may further include thermal barriers. While FIGS. 11 and 12 show the first, second, and third cooling fluid flowpaths 443, 445, 447 arranged along the second axis Ax2, the present disclosure is not limited thereto, and any number of cooling fluid flowpaths may be arranged along the second axis Ax2.

The first, second, and third flowpath inlets 443i, 445i, 447i may be coupled to one end of one or more cooling system flow loops 510, and the first, second, and third flowpath outlets 4430, 4450, 4470 may be coupled to the other end of one or more cooling system flow loops 510. Thus, cold cooling fluid may flow into the cooling structure 400 from the first, second, and third flowpath inlets 443i, 445i, 447i absorb heat from the main body 441, and the heated cooling fluid may flow out of the cooling structure 400 from the first, second, and third flowpath outlets 4430, 4450, 4470. The heated cooling fluid may then be cooled via the heat exchanger 530 and flow back into the cooling structure 400.

FIG. 13 shows an ICB assembly 300 according to one or more embodiments. The battery cell 200 and the ICB assembly 300 shown in FIG. 13 is similar to that shown in FIG. 2 and, as such, descriptions of the similar portions are not repeated. A battery cell 200 according to one or more embodiments may include an upper vent 214 formed in the upper wall 213 of the can 210 facing the ICB assembly 300. In such a case, a thermal interface material disposed above the upper vent 214 may block ventilation of the can 220. As such, the battery assembly 100 may include a gap 341 between the upper vent 214 and the ICB assembly 300. Furthermore, the ICB assembly 300 may include a first cooling structure 400A and a second cooling structure 400B arranged along the second axis Ax2, with the ICB frame 310 defining a cell venting space 340 between the first cooling structure 400A and the second cooling structure 400B. Thus, the heat vented from the upper vent 214 of the battery cells 200 may be transferred via convection to the first cooling structure 400A, the second cooling structure 400B, and the cell venting space 340. Each of the first cooling structure 400A and the second cooling structure 400B may be structured similarly to the cooling structures 400 disclosed herein. The ICB frame 310 may include openings (not shown) below the cell venting space 340 to vent air above the ICB frame 310.

FIG. 14 shows an ICB assembly 300 according to one or more embodiments. The ICB assembly 300 shown in FIG. 14 is similar to that shown in FIG. 2 and, as such, descriptions of the similar portions are not repeated. The ICB assembly 300 may include a first thermal bridge plate 351 and a second thermal bridge plate 352 on a lower side of the ICB assembly 300 along the first axis Ax1. The first thermal bridge plate 351 is in contact with the thermal interface material 330 and extends along the second axis Ax2 to overlap the first bus bar 321 along the first axis Ax1, and the second thermal bridge plate 352 is in contact with the thermal interface material 330 and extends along the second axis Ax2 to overlap the second bus bar 323 along the first axis Ax1. The first thermal bridge plate 351 and the second thermal bridge plate 352 may be thermal conductors and electrical insulators. The first thermal bridge plate 351 may overlap the first electrode terminal 222 and the first ICB terminal 325 (not shown) along the first axis Ax1, and first thermal bridge plate 351 and the second thermal bridge plate 352 may be thermal conductors and electrical insulators. The second thermal bridge plate 352 may overlap the second electrode terminal 224 and the second ICB terminal 326 (not shown) along the first axis Ax1. The first thermal bridge plate 351 may transfer heat from the first bus bar 321, the first ICB terminal 325, and/or the first electrode terminal 222 to the cooling structure 400 via the thermal interface material 330. The second thermal bridge plate 352 may transfer heat from the second bus bar 323, the second ICB terminal 326, and/or the second electrode terminal 224 to the cooling structure 400 via the thermal interface material 330.

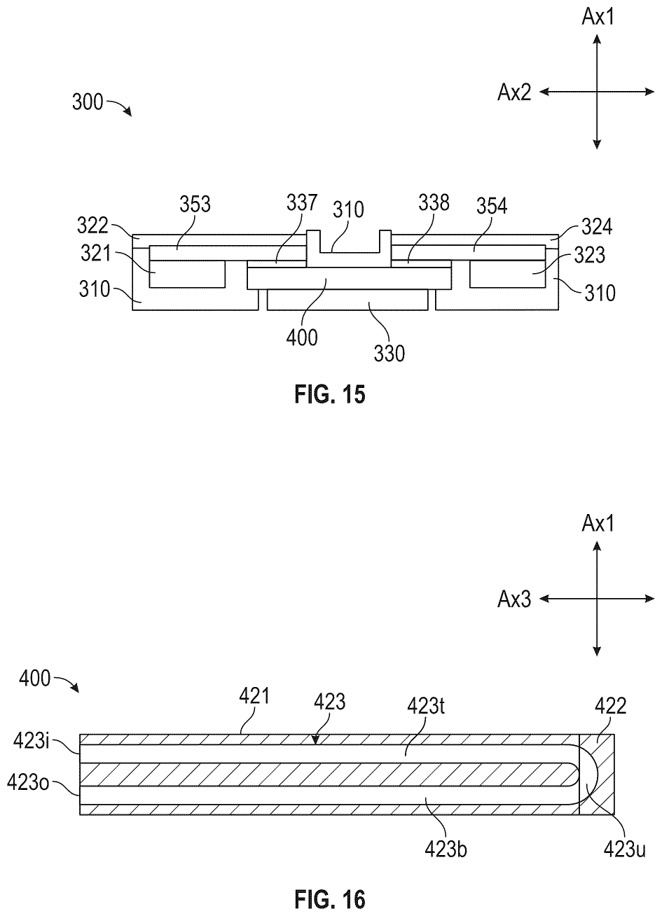

FIG. 15 shows an ICB assembly 300 according to one or more embodiments. The ICB assembly 300 shown in FIG. 15 is similar to that shown in FIG. 2 and, as such, descriptions of the similar portions are not repeated. The ICB assembly 300 may include thermal interface materials 337, 338 on a top surface of the cooling structure 400 along the first direction Ax1, and a third thermal bridge plate 353 and a fourth thermal bridge plate 354 contacting upper surfaces of the thermal interface materials 337, 338 along the first axis Ax1. The thermal interface materials 337, 338 may be gap fillers, and may be formed of aluminum oxide polyurethane, aluminum tri-hydrate polyurethane, or any other type of thermally conductive material known in the art.

The third thermal bridge plate 353 may extend along the second axis Ax2 to overlap the first bus bar 321 along the first axis Ax1, and the fourth thermal bridge plate 354 may extend along the second axis Ax2 to overlap the second bus bar 323 along the first axis Ax1. The third thermal bridge plate 353 may be in contact with an upper surface of the first bus bar 321 along the first axis Ax1, and the fourth thermal bridge plate 354 may be in contact with an upper surface of the second bus bar 323 along the first axis Ax1. The third thermal bridge plate 353 and the fourth thermal bridge plate 354 may be thermal conductors and electrical insulators. The third thermal bridge plate 353 may transfer heat from the first bus bar 321 to the cooling structure 400 via the thermal interface material 337. The fourth thermal bridge plate 354 may transfer heat from the second bus bar 323 to the cooling structure 400 via the thermal interface material 338.

FIG. 16 shows a cooling structure 400 according to one or more embodiments. The cooling structure 400 shown in FIG. 16 is similar that that shown in FIG. 8, except that the flowpath bend portion 423u is formed within an end cap 422 attached to a rear end of the main body 421 along the third axis Ax3. The end cap 422 may be formed separately from the main body 421 to simplify the manufacturing process of the cooling structure 400.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery assembly defining a first axis, a second axis orthogonal to the first axis, and a third axis orthogonal to the first axis and the second axis, the battery assembly comprising:
a plurality of battery cells arranged along the third axis; and
an integrated circuit board (ICB) assembly disposed adjacent to the battery cells along the first axis and electrically coupled to the plurality of battery cells;
wherein the ICB assembly comprises a cooling structure thermally coupled to the battery cells, and
wherein the cooling structure comprises a main body defining at least one cooling fluid flowpath configured to have cooling fluid pass therethrough to remove heat from the battery cells.

2. The battery assembly of claim 1, wherein the at least one cooling fluid flowpath comprises a first portion extending along the third axis and a second portion extending along the third axis disposed adjacent to the first portion along the first axis.

3. The battery assembly of claim 2, wherein a thermal barrier is disposed between the first portion and the second portion.

4. The battery assembly of claim 3,
wherein the main body is formed of a first body defining the first portion and a second body defining the second portion;
wherein the first body is separate from the second body, and
wherein the thermal barrier is disposed between the first body and the second body.

5. The battery assembly of claim 2,
wherein the first portion is a first flowpath extending from a first flowpath inlet disposed at one end of the main body along the third axis to a first flowpath outlet disposed at another end of the main body along the third axis, and
wherein the second portion is a second flowpath extending from a second flowpath inlet disposed at the one end of the main body along the third axis to a second flowpath outlet disposed at the other end of the main body along the third axis.

6. The battery assembly of claim 2,
wherein the first portion extends from a flowpath inlet disposed at one end of the main body along the third axis to a flowpath bend portion;
wherein the second portion extends from the flowpath bend portion to a flowpath outlet disposed at the one end of the main body along the third axis, and
wherein the flowpath bend portion fluidly couples the first portion to the second portion.

7. The battery assembly of claim 6, wherein the main body comprises an end cap that that defines the flowpath bend portion.

8. The battery assembly of claim 1,
wherein the at least one cooling fluid flowpath comprises a first flowpath and a second flowpath arranged adjacent to the first flowpath;
wherein the first flowpath extends from a first flowpath inlet disposed at one end of the main body along the third axis to a first flowpath bend portion and further extends from the first flowpath bend portion along the third axis to a first flowpath outlet disposed on the one end of the main body, and
wherein the second flowpath extends from a second flowpath inlet disposed at the one end of the main body along the third axis to a second flowpath bend portion and further extends from the second flowpath bend portion along the third axis to a second flowpath outlet disposed on the one end of the main body.

9. The battery assembly of claim 1,
wherein each of the battery cells comprises a can and an electrode stack disposed within the can, and
wherein a thermal interface material is disposed between and in contact with the can and the cooling structure to transfer heat from the can to the cooling structure.

10. The battery assembly of claim 9, wherein a thermally conductive material is disposed between and in contact with the electrode stack and an inner surface of a portion of the can that contacts the thermal interface material.

11. The battery assembly of claim 1,
wherein the ICB assembly comprises a first bus bar and a second bus bar, each of which is electrically coupled to one or more the battery cells, and
wherein the cooling structure is disposed between the first bus bar and the second bus bar along the second axis.

12. The battery assembly of claim 9,
wherein the ICB assembly comprises a first bus bar and a second bus bar, each of which is electrically coupled to one or more the battery cells, and
wherein the cooling structure is disposed between the first bus bar and the second bus bar along the second axis.

13. The battery assembly of claim 12,
wherein a first thermal bridge plate and a second thermal bridge plate are disposed on a side of the ICB assembly facing the battery cells along the first axis;
wherein the first thermal bridge plate extends along the second axis from the thermal interface material to a position overlapping the first bus bar along the first axis,
wherein the second thermal bridge plate extends along the second axis from the thermal interface material to a position overlapping the second bus bar along the first axis, and
wherein the first thermal bridge plate and the second thermal bridge plate are thermal conductors and electrical insulators.

14. The battery assembly of claim 13, wherein the first thermal bridge plate and the second thermal bridge plate comprises a ceramic material.

15. The battery assembly of claim 11,
wherein first and second thermal interface materials are disposed on a side of the cooling structure opposite the battery cell;
wherein a first thermal bridge plate extends along the second axis so as to overlap and be in contact with the first bus bar and the first thermal interface material along the first axis, and
wherein a second thermal bridge plate extends along the second axis so as to overlap and be in contact with the second bus bar and the second thermal interface material along the first axis.

16. The battery assembly of claim 1, wherein the ICB assembly comprises a plurality of the cooling structure arranged along the second axis.

17. The battery assembly of claim 1, wherein a flowpath inlet of the at least one cooling fluid flowpath and a flowpath outlet of the at least one cooling fluid flowpath are fluidly coupled to a pump and a heat exchanger, to form a cooling fluid loop.

18. The battery assembly of claim 1, further comprising cooling plates disposed on sides of the battery cell along the second axis.

19. An integrated circuit board (ICB) assembly for a battery assembly defining a first axis, a second axis orthogonal to the first axis, and a third axis orthogonal to the first axis and the second axis, the ICB assembly comprising:
an integrated circuit board (ICB) assembly configured to be disposed adjacent to a plurality of battery cells along the first axis and configured to be electrically coupled to the plurality of battery cells;
wherein the ICB assembly comprises a cooling structure configured to be thermally coupled to the battery cells, and
wherein the cooling structure comprises a main body defining at least one cooling fluid flowpath configured to have cooling fluid pass therethrough to remove heat from the battery cells.

20. A vehicle, comprising:
a battery assembly defining a first axis, a second axis orthogonal to the first axis, and a third axis orthogonal to the first axis and the second axis, the battery assembly comprising:
a plurality of battery cells arranged along the third axis; and
an integrated circuit board (ICB) assembly disposed adjacent to the battery cells along the first axis and electrically coupled to the plurality of battery cells;
wherein the ICB assembly comprises a cooling structure thermally coupled to the battery cells;
wherein the cooling structure comprises a main body defining at least one cooling fluid flowpath configured to have cooling fluid pass therethrough to remove heat from the battery cells;
wherein the at least one cooling fluid flowpath comprises a first portion extending along the third axis and a second portion extending along the third axis disposed adjacent to the first portion along the first axis or the second axis;
wherein the ICB assembly comprises a first bus bar and a second bus bar, each of which is electrically coupled to one or more the battery cells, and
wherein the cooling structure is disposed between the first bus bar and the second bus bar along the second axis.
